(19) United States
(12) Patent Application Publication
(10) Pub. No.: US 2002/0112191 A1
(43) Pub. Date: Aug. 15, 2002

(54) Intelligent power module for highly available compact PCI board

(76) Inventors: Gerald R. Pelissier, Santa Clara, CA (US); David S. Hwang, Sunnyvale, CA (US)

Correspondence Address: ROSENTHAL & OSHA L.L.P., 1221 MCKINNEY AVENUE, SUITE 2800, HOUSTON, TX, 77010, US

(21) Appl. No.: 09/784,482

(22) Filed: Feb. 15, 2001

Related U.S. Application Data
(60) Provisional application No. 60/242,247, filed on Oct. 20, 2000.

(51) Int. Cl. G06F 1/26; G06F 1/28; G06F 1/30

(52) U.S. Cl. 713/300

(57) ABSTRACT

An intelligent power module includes a power supply, control circuitry controlling whether power is delivered by the power supply and a controller that determines a status of the power supply and instructs the control circuitry to control whether power is delivered by the power supply based on the status of the power supply. A method of intelligently supplying power includes determining a state of a power supply and selectively turning on the power supply based on the state of the power supply. An intelligent power delivery system includes a backplane, a system management controller residing on the backplane, and a power module operatively coupled to the backplane. The system management controller monitors a state of the power module prior to powering on the power module. An apparatus for intelligently supplying power includes means for delivering power, means for determining a state of the power delivery means, and means for controlling whether the power delivery means delivers power based on the state of the power delivery means determined. A computer includes a power supply, control circuitry controlling whether power is delivered by the power supply, and a controller that determines a status of the power supply and instructs the control circuitry to control whether power is delivered by the power supply based on the status of the power supply.

### CROSS REFERENCE TO RELATED APPLICATIONS

This application claims priority under Section 119 of U.S. Provisional Application No. 60/242,247 filed on Oct. 20, 2000.

### BACKGROUND OF THE INVENTION

Referring to FIG. 1, computer systems generally comprise, among other elements, a motherboard (10), a central processing unit (CPU) (12), memory (14), and a plurality of circuit cards (16) for controlling components, performing functions, and the like. Most of these elements are inserted or otherwise electrically connected to the motherboard. As used herein and will be understood by those skilled in the art, motherboard refers to any printed circuit board including, but not limited to, passive backplanes, active backplanes, etc. Computer system components are generally connected via buses (18), or electrically conductive path traced along the motherboard. These buses are used for data transfer among the components. Further, power is delivered to the motherboard through a power connection (20). Then, depending on the component, power is supplied indirectly from the motherboard (10) or directly via a power connection on the component. In certain systems, the elements can be removed from or inserted into the computer while the system is running, i.e., the elements can be “hot-swapped.”

There exist standard specifications that allow the combination of components from different manufacturers. ISA (Industry Standard Architecture) is a bus specification that is based on that used in the IBM PC/XT and PC/AT. PCI (Peripheral Component Interconnect) is a local bus specification developed for 32-bit or 64-bit computer system interfacing. Most modern computers have both an ISA bus for slower devices and a PCI bus for devices that need better bus performance. Another specification, VME (VersaModule Eurocard bus) is a 32-bit bus widely used in industrial, commercial, and military applications. VME64 is an expanded version that provides 64-bit data transfer and addressing.

While it is generally cost effective to have most of the circuitry on a single large motherboard for desktop computers, such a configuration has certain drawbacks that are particularly important to industrial applications. Because the motherboard is usually thin and large enough to flex, breakage of small traces and solder joints on fine pitch surface mount devices may occur when plug-in boards are inserted. The occurrence of such breakage dictates motherboard replacement, which requires complete disassembly and reassembly of the computer system.

Particularly in industrial applications, such disassembly and reassembly, and the accompanying downtime, may be unacceptable. Also, given the rapid development of motherboard technology, finding an exact replacement for a motherboard can be difficult or impossible. Further, substitution of a non-exact replacement may cause software problems due to BIOS changes, changing device drivers, and different timing. Thus, standard specifications have been developed systems and boards for use in industrial and telecommunications computing applications.

The PCI-ISA passive backplane standard defines backplane and connector standards for plug-in passive backplane CPU boards that bridge to both PCI and ISA buses. The PCI-ISA passive backplane standard moves all of the components normally located on the motherboard to a single plug-in card. The motherboard is replaced with a “passive backplane” that only has connectors soldered to it.

CompactPCI is a specification for PCI-based industrial computers that is electrically a superset of PCI with a different physical form factor. CompactPCI uses the Eurocard form factor popularized by the VME bus. The CompactPCI Bus Specification restricts the values of the bus pull-ups to either 2.7K ohm (Ω) (±5%), or 1.0 KΩ (±5%) for 3.3 Volt (V) and 5V backplanes, respectively.

In the PCI specification, it was possible to select a single value for the pull-up resistor that would satisfy the requirement for both 3.3V and 5V backplanes. Therefore, it was possible to create Universal Signaling Environment capable cards. There is a mechanism defined by the PCI specification where the “signaling environment” of the bus is defined by the value of the VIO pins (either 3.3V or 5V). Thus, a universal card uses VIO to define its own I/O voltage, rather than fixing it at 5V or 3.3V.

The CompactPCI bus architecture supports 3.3V signaling environment, 5V signaling environment, and hot swap. These features have the following corresponding requirements. The 3.3V signaling environment requires 2.7 KΩ (±5%) pull-up resistors. The 5V signaling environment requires 1.0 KΩ (±5%) pull-up resistors. Hot Swap requires that all pins be biased at 1V (±20%) using a minimum 10 KΩ pull-up resistor. Further, the CompactPCI specification has the additional requirements of 10 Ω series termination resistor on every signal within 0.6″ of the connector pin, no more than 10 Pico-Farad (pf) capacitive load on any shared bus signal on a non-system slot board, and no more than 20 pf capacitive load on any shared bus signal on a system slot board.

There are two types of “universal” boards: Universal signaling environment and universal slot location. Universal signaling environment means that a board can operate in either a 3.3V or 5V bus backplane. With the original PCI specification, it was possible to select a value for the bus pull-up resistor that satisfied the specification for both the 3.3V and 5V signaling environments. With the CompactPCI Specification, it is no longer possible to select a single resistor. Therefore, in order to be a universal signaling environment capable CompactPCI board, a board must provide both 2.7 KΩ (±5%) and 1.0 KΩ (±5%) pull-up resistors and provide a way to enable them correctly depending on the signaling environment.

Universal slot location describes a board that can function in either the system slot or non-system slot of a CompactPCI backplane. A system slot board is required to provide the common bus resources for the CompactPCI backplane, namely: bus pull-ups, bus clock, and the bus arbiter. A system slot board is allowed additional capacitive load per signal pin because of these additional features. In order to be CompactPCI Hot Swap Specification compliant, every signal pin must be biased to (1V±20%) through a minimum 10 KΩ resistor prior to insertion into a live or “hot” backplane.

Also, in a highly available/hot-swappable system, there exists a state of “alwayson.” This “always-on” state exists even when the system is officially off-line and powered down. In such a system, there is a system management controller still receiving power and responsible for determining whether to power up the remainder of the system, e.g., the “host CPU” and subsystems on or connected to the backplane.

Hot-insertion of a CompactPCI board into a live backplane occurs in several stages. First, the on-board system management controller is powered up. After powering up, the on-board system management controller is responsible for determining whether to power up the “host CPU” and its subsystems. This creates a situation where the board is live to a degree, when the system management controller (responsible for managing the hardware state) is powered up, but the Host CPU and its subsystems (defining the main functionality of the board) are powered off.

Those skilled in the art will appreciate that other requirements exist in the full CompactPCI specification, Hot Swap Specification, Passive Backplane PCI-ISA Specification, which are all available from PCI Industrial Computer Manufacturers Group of Wakefield, Mass. and are all hereby incorporated in their entirety by reference.

### SUMMARY OF THE INVENTION

In one aspect, an intelligent power module comprises a power supply; control circuitry controlling whether power is delivered by the power supply; and a controller that determines a status of the power supply and instructs the control circuitry to control whether power is delivered by the power supply based on the status of the power supply.

In one aspect, a method of intelligently supplying power comprises determining a state of a power supply; and selectively turning on the power supply based on the state of the power supply.

In one aspect, an intelligent power delivery system comprises a backplane; a system management controller residing on the backplane; and a power module operatively coupled to the backplane, wherein the system management controller monitors a state of the power module prior to powering on the power module.

In one aspect, an apparatus for intelligently supplying power comprises means for delivering power; means for determining a state of the power delivery means; and means for controlling whether the power delivery means delivers power based on the state of the power delivery means determined.

In one aspect, a computer comprises a power supply; control circuitry controlling whether power is delivered by the power supply; and a controller that determines a status of the power supply and instructs the control circuitry to control whether power is delivered by the power supply based on the status of the power supply. Other aspects and advantages of the invention will be apparent from the following description and the appended claims.

### BRIEF DESCRIPTION OF THE DRAWINGS

FIG. 1 shows a typical computer system.

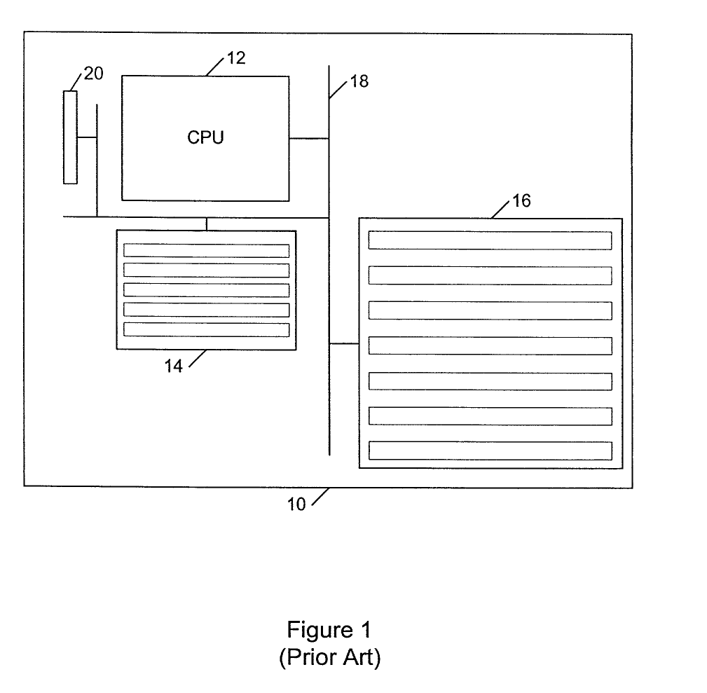

FIG. 2 is a block diagram in accordance with an embodiment of the present invention.

FIG. 3 is a flow chart showing a process in accordance with an embodiment of the present invention.

### DETAILED DESCRIPTION OF THE INVENTION

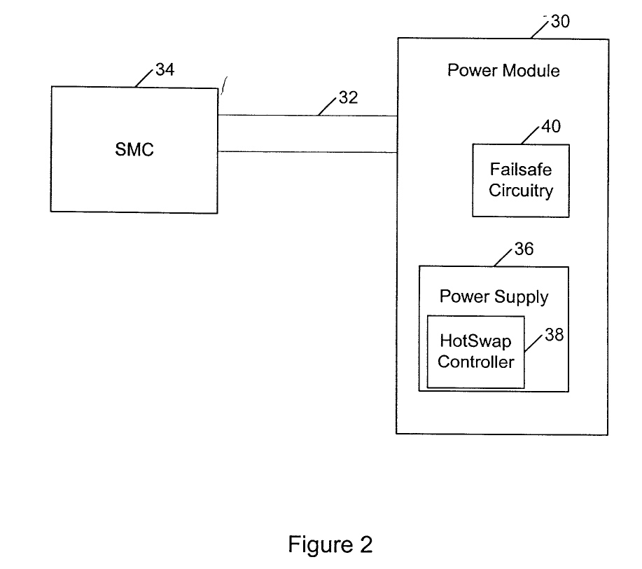

In one or more embodiments, the present invention involves an intelligent power module. Referring to the drawings wherein like reference characters are used for like parts throughout the several views, FIG. 2 shows a block diagram of a computer system in accordance with an embodiment of the present invention.

Using power provided by the backplane, a controller, e.g., a system management controller, can probe the state of the main board before powering up the rest of the board. In order to perform these functions, an intelligent power module is required. In one embodiment, an intelligent power module (30) includes a power supply (36) that is a self-contained DC/DC converter with an on-board HotSwap controller (38) for the CompactPCI voltages ±12V, 5V, and 3.3V. A 16 Watt (W) programmable output voltage in the range of 2.05V to 1.3V is derived off the +5V. The output programmability of power module (30) is controlled and tasks are monitored via an I²C bus interface (32). The power module (30) is connected to a System Management Controller (SMC) (34) through a two-wire I²C interface (32). Via the I²C interface (32), the SMC (34) can access, modify, and control components on the power module (30), e.g., soft power on/off the power supply (36). In one embodiment, the state the power supply (36) is monitored prior to powering on the power supply (36).

Further, in one embodiment, the power module (30) may include hardware overcurrent protection circuit (40), i.e., a hardware failsafe that shuts down the power rails in the event of overcurrent on any of the rails. The failsafe circuit (40) is used to automatically provide failsafe control for system board protection. No software intervention is required for activation of the hardware failsafe (40). However, if the failsafe triggering condition occurs, the power module (30) may drive an alarm signal, which sends an interrupt to the SMC (34).

The CompactPCI Hot Swap Specification requires that all the signals on a board that will be hot-plugged into a live CompactPCI backplane need to be biased to 1V, Vp, prior to making contact with their corresponding pins on the backplane. Specifically, the bias voltage shall appear at the board connector contacts before the board engages the backplane. Likewise, when the board is removed, the bias voltage shall appear at the board connector contacts after the board disengages the backplane. The optimal bias voltage is 1.0V with an allowable tolerance of ±20%. The CompactPCI board shall have a pre-charge bias voltage applied to all CompactPCI signals. The board's pre-charge bias voltage source shall be capable of charging the onboard network to within 80% of the nominal 1.0V pre-charge voltage within 5 microseconds.

The CompactPCI Hot Swap Specification also defines longer “Early Power” pins on the backplane connect that are longer than the signal pins, and Vp must be derived from one of these pins, i.e., early 12V, 5V, or 3.3V. Vp should be generated as soon as possible in order to bias the signals before the signal pins on the board make contact with the corresponding shorter signal pins on the backplane. In one embodiment, once these pins make contact with the backplane, the SMC (34) can query the power module (30).

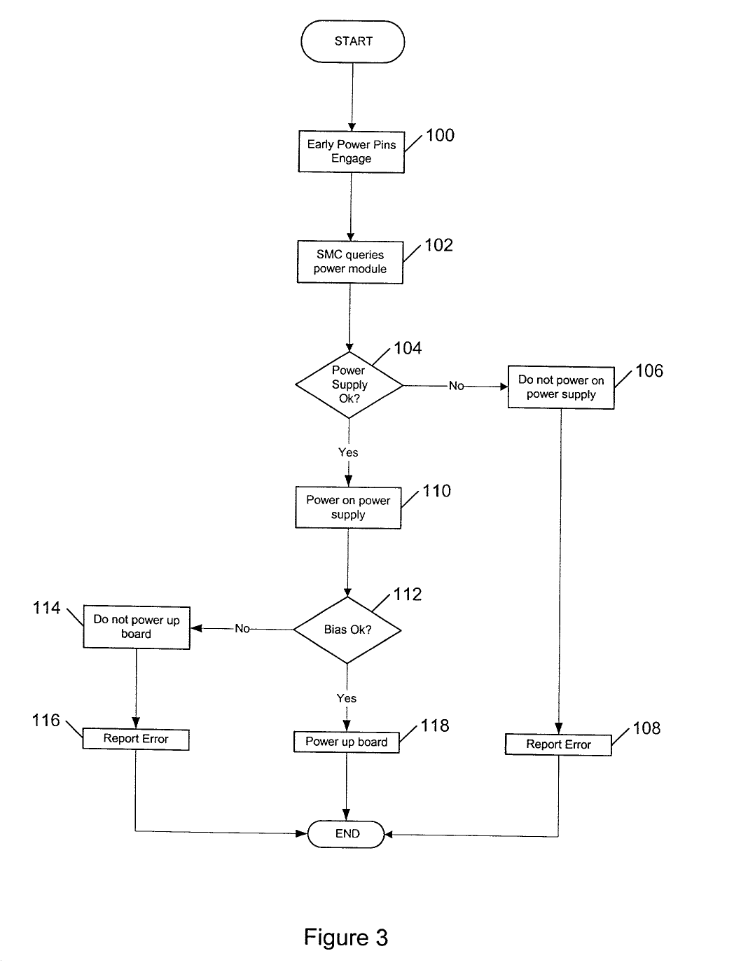

FIG. 3 is a flow chart describing insertion of an intelligent power module. At the insertion of the power module into the backplane, the longer “early” power pins make contact (step 100). At that point, the SMC on the backplane can access the power module. When the SMC queries the power module (step 102), the status of the power supply is determined (step 104). If the power supply is not properly operating, the SMC instructs the on-board control circuitry not to power up the power supply (step 106). Then, an error may be reported (step 108) so that a user knows remedial measures need to be taken and the process ends.

On the other hand, when the power supply is properly operating (step 104), the SMC instructs the on-board control circuitry to power on the power supply (step 110). Once powered on, the power supply should be delivering bias voltage to the shorter connect pins, i.e., non-early power pins. Thus, the SMC may next monitor whether the bias voltage is appearing on these pins (112). If not, the SMC instructs the on-board control circuitry not to power up the components on the board (114) as powering up the components in the presence of improper bias voltage may result in damage or destruction of the components. Otherwise, in situations where the bias voltage properly appears on the pins (step 112), the SMC proceeds instructing the on-board control circuitry to power up the board (step 118) and the process ends.

Those skilled in the art will appreciate that the embodiments described above may be reconfigured based on design requirements or preference. For example, the failsafe hardware be implemented in software or may be omitted from boards where other failsafe measures are present in the system. Also, the off-board SMC may be programmed to query the intelligent power module only and additional control software may be included on-board, in, for example, the HotSwap Controller, to provide diagnostic functionality for the components on the board.

Advantages of the present invention may include one or more of the following. A CompactPCI board's own power supply is monitored prior to being powered up. Access, modification, and control of the power module is handled by software via an I²C bus interface. An intelligent power module includes software control of power on/off, software control of power supply configuration (e.g., setting the value of VDD core), software access to the “module ID,” and software interrupts for use in case of catastrophic failure or shut down. Through detection of a module ID, the power supply can readily be identified in the system. Also, firmware/software on a controller, e.g., system management controller, can control the power module functions. The power module can supply a minimum of 13 μA (86 signals with 10K minimum pull-up to Vp). The pre-charge circuit sinks a minimum of 40.3 mA when the board completes insertion into the 5V PCI bus and puts a voltage across the 10K pull-up to Vp.

While the invention has been described with respect to a limited number of embodiments, those skilled in the art will appreciate that other embodiments can be devised which do not depart from the scope of the invention as disclosed herein. Accordingly, the scope of the invention should be limited only by the attached claims.

What is claimed is:

1. An intelligent power module comprising:
a power supply;
control circuitry controlling whether power is delivered by the power supply; and
a controller that determines a status of the power supply and instructs the control circuitry to control whether power is delivered by the power supply based on the status of the power supply.

2. The intelligent power module of claim 1 further comprising:
failsafe circuitry controlling access to the power supply,
wherein the failsafe circuitry disables access to the power supply upon component failure.

3. The intelligent power module of claim 1 wherein the controller is a system management controller.

4. The intelligent power of claim 3, wherein the system management controller is external to the power module, the power module further comprising:
an interface for allowing the system management controller to operatively connect to the power supply.

5. The intelligent power module of claim 4 wherein the interface is an I²C interface.

6. A method of intelligently supplying power comprising:
determining a state of a power supply; and
selectively turning on the power supply based on the state of the power supply.

7. The method of claim 6 further comprising:
disabling access to the power supply upon component failure.

8. The method of claim 6, comprising:
interfacing with an external controller; and
selectively turning on the power supply based on instructions from the external controller.

9. An intelligent power delivery system comprising:
a backplane;
a system management controller residing on the backplane; and
a power module operatively coupled to the backplane,
wherein the system management controller monitors a state of the power module prior to powering on the power module.

10. The system of claim 9 wherein the power module is in compliance with CompactPCI requirements.

11. An apparatus for intelligently supplying power comprising:
means for delivering power;
means for determining a state of the power delivery means; and
means for controlling whether the power delivery means delivers power based on the state of the power delivery means determined.

12. A computer comprising:
a power supply;
control circuitry controlling whether power is delivered by the power supply; and
a controller that determines a status of the power supply and instructs the control circuitry to control whether power is delivered by the power supply based on the status of the power supply.
